(19) United States
(12) Patent Application Publication
(10) Pub. No.: US 2026/0318443 A1
(43) Pub. Date: Oct. 15, 2026

(54) VALVE BODY, PROCESS VALVE, METHOD AND CONTROL UNIT

(71) Applicant: GEMÜ Gebr. Müller Apparatebau GmbH & Co. Kommanditgesellschaft, Kupferzell (DE)

(72) Inventors: Johann Magej, Schwäbisch Hall (DE); Elena Zuck, Bad Wimpfen (DE); Nicolas Lehner, Mulfingen-Eberbach (DE); Maximilian Bauer, Forchtenberg (DE); Gert Müller, Künzelsau (DE)

(21) Appl. No.: 19/641,794

(22) Filed: Apr. 8, 2026

(30) Foreign Application Priority Data
Apr. 11, 2025 (DE) 10 2025 114 330.7

(51) Int. Cl. F16K 37/00; F16K 7/12

(52) U.S. Cl. CPC F16K 37/0083; F16K 7/126

(57) ABSTRACT

A valve body for a process valve includes at least two process fluid channels extending to a valve seat and at least partially defining an inner chamber. An opening spaced from the valve seat extends into one of the process fluid channels and is closed by a light-and/or sound-transparent element that partially forms an inner wall of the process fluid channel. The valve body can include a light source, a sound source, and/or a sensor device configured to couple light or sound into the inner chamber and to receive light or sound from the inner chamber to generate a sensor signal. A process valve including the valve body, a shut-off body, and a drive is also disclosed. Further disclosed are methods for imaging a wet-side surface of the shut-off body, evaluating valve closure quality, determining process fluid turbidity, and controlling valve operation based on sensed conditions.

### TECHNICAL FIELD

This disclosure relates generally to process valves and, more particularly, to valve bodies, process valves, operating methods, and control units that facilitate optical and/or acoustic interrogation of an internal valve chamber, including inspection of internal surfaces, monitoring of valve closure, and determination of process fluid characteristics such as turbidity.

### BACKGROUND

In process engineering, various parameters in the process plant must be captured and monitored in order to prevent unnecessary waste, especially the loss of entire batches. Process valves, including diaphragm valves, are critical components in such plants. Over time, shut-off bodies such as valve diaphragms can develop surface defects including cracks, folds, and other irregularities that can compromise sealing performance and process integrity. Conventional inspection of these wet-side surfaces typically requires disassembly of the valve, which is time-consuming, introduces contamination risks, and interrupts production.

### SUMMARY

In one aspect, the present disclosure provides a valve body for a process valve, the valve body comprising: at least two process fluid channels which extend to at least one valve seat of the valve body and at least partially delimit, together with the valve seat, an inner chamber of the valve body; and at least one opening at a distance from the valve seat, which extends into or opens into one of the two process fluid channels of the inner chamber of the valve body, and which is closed by a light-and/or sound-transparent element, the surface of which that faces one of the at least two process fluid channels (110, 120) partially forms an inner wall that delimits one of the at least two process fluid channels (110, 120).

The opening formed in a wall of the valve body, which is closed by the light- and/or sound-transparent element or disk, makes it possible to easily integrate a plurality of optical applications into the valve body. In particular, measurements relating to the inner chamber can be carried out more easily, since the light- and/or sound-transparent element decouples the arrangement of the sensor system from the arrangement relating to the inner chamber and from the fluid contact issue. This decoupling is particularly advantageous because the components involved in the optical application are not exposed to any of the high pressures and pressure surges prevailing in the inner chamber. It is rather the case that the light- and/or sound-transparent element ensures that the body is sealed toward the outside and at the same time provides a window for looking into the inner chamber of the valve body.

Advantageously, the sound waves and/or light waves transmitted through the light- and/or sound-transparent element are decoupled from a valve function, which improves the application range of the valve body. In some embodiments, the valve body comprises: at least one light source and/or sound source, which is configured to generate light and/or sound in response to an actuation signal that is supplied and to couple the light generated by the at least one light source and/or the sound generated by the at least one sound source through the light- and/or sound-transparent element and into the inner chamber of the valve body that is separated by the light- and/or sound-transparent element.

Light or sound coupled in through the light- and/or sound-transparent element creates light and/or sound in the inner chamber that is either filled with process fluid or is empty. The light- and/or sound-transparent element allows degrees of freedom when configuring the light source or the sound source. For example, the light source or sound source does not have to withstand high fluid pressures, as it is located outside the inner chamber and is exposed to atmospheric pressure.

In some embodiments, the light emitted by the at least one light source at least partially comprises UV-C light, in particular within the wavelength range of about 200 to 280 nanometers.

UVC light can be advantageously used for germicidal purposes in the inner chamber of the valve body, either for the inner walls of the valve body or for the process fluid. UV-C radiation works by destroying the DNA or RNA of microorganisms. This inactivates or kills bacteria, viruses and other germs.

In some embodiments, the valve body comprises: at least one sensor device which is configured to receive incident light and/or sound from the inner chamber separated by the light- and/or sound-transparent element and to generate a sensor signal which represents at least one characteristic of the incident light and/or sound via the light- and/or sound-transparent element.

This advantageously allows conclusions to be drawn about the state inside the valve body without the valve body having to be opened. It is conceivable not only to ascertain the state of a process fluid in the inner chamber of the valve body but also to evaluate an empty state of the inner chamber.

In some embodiments, the at least one sensor device is configured to capture at least some of the wavelength ranges of the light generated by the at least one light source and emitted into the inner chamber of the valve body via the light- and/or sound-transparent element, and/or to capture at least some of the wavelength ranges of the sound generated by the at least one light source and coupled into the inner chamber of the valve body via the light- and/or sound-transparent element.

Advantageously, the at least one light source and/or sound source can be actively used to assist the sensor unit with ascertaining the state inside the valve body.

In some embodiments, the valve body comprises: a plurality of openings that are at a distance from one another and in each case extend into the inner chamber of the valve body, wherein each of the openings is closed by an associated light- and/or sound-transparent element.

This advantageously creates further ways of coupling light and/or sound into the inner chamber and/or monitoring the inner chamber by means of an additional sensor device.

In some embodiments, the valve body comprises: a plurality of light sources and/or sound sources, which are designed to generate light and/or sound in response to an actuation signal that is supplied, in particular individually, and to couple the light generated by each light source and/or the sound generated by each sound source into the inner chamber of the valve body through a different light- and/or sound-transparent element of the plurality of light- and/or sound-transparent elements each time.

Advantageously, a desired light distribution or sound distribution can be radiated into the valve body by selectively switching each of the plurality of light sources or sound sources on and off. This makes it possible to create of different lighting and sound scenarios in the inner chamber.

In some embodiments, the valve body comprises: a plurality of sensor devices which are designed to receive incident light and/or sound from the inner chamber that is separated by the associated light- and/or sound-transparent element and to generate a respective sensor signal, which represents the at least one characteristic of the incident light and/or sound through the associated light- and/or sound-transparent element and/or represents at least another characteristic of the incident light and/or sound through the associated light- and/or sound-transparent element.

Advantageously, a plurality of regions of the inner chamber of the valve body can be monitored by means of a plurality of sensor devices, which are associated with different light- and/or sound-transparent elements, each of which closes different openings in the valve body.

In some embodiments, the valve seat of the valve body divides the inner chamber into a first part and a second part, in particular into the first and second process fluid channels, wherein a first of the openings extends into the first part of the inner chamber, and wherein a second of the openings extends into the second part of the inner chamber.

Advantageously, the inner chamber can be observed and/or provided with light and/or sound from two different sides of the valve seat. This provides advantages in terms of coupling-in and detecting light.

In some embodiments, the at least one sensor device or the plurality of sensor devices is/are configured to generate at least one digital image representing a state of at least part of the inner chamber of the valve body as the at least one characteristic in the form of the at least one sensor signal or in the form of each of the plurality of sensor signals.

The provision of such a sensor device forms the basis for a detailed analysis of the inner chamber during operation of the process valve. In particular, this advantageously makes it possible to inspect the inner chamber without disassembling the individual components. Specific indications of a defect spreading in the inner chamber can thus be given on the basis of the imaging sensor signal.

It is therefore advantageously possible to take photographs, which can be evaluated by machine or by a person, of the wet side of the diaphragm, which is wetted by process fluid during normal operation, at least during operating phases in which the process valve is free of process fluid, without the process valve having to be dismantled.

The movement of the valve diaphragm can be filmed, particularly during a period when there is no medium, for example after cleaning, by obtaining multiple images. This could allow hidden folds or cracks to be detected more effectively. In other words, a large number of images are created in small steps as the shut-off body is raised. The reason for this is that an existing crack is only visible in a specific position of the valve diaphragm and can be overlooked if only one photo was taken in an “unfavorable” position of the valve diaphragm. This will further improve monitoring.

In some embodiments, a region of the valve body, in which a shut-off body moves to open and close the process valve during operation of the process valve, lies at least partially within a field of view of the at least one or of each sensor device.

This makes it possible for the sensor device to generate an image that depicts the wet-side surface of the shut-off body and its current state when installed.

In some embodiments, the at least one light source, which is designed, together with a first associated light- and/or sound-transparent element of the plurality of light- and/or sound-transparent elements, to couple light, in particular monochromatic light, in the form of a light distribution, in particular a collimated light distribution, into the inner chamber of the valve body in a main emission direction; and the at least one sensor device, wherein the at least one sensor device is designed, together with a second associated light- and/or sound-transparent element, to capture at least a light intensity of light scattered by suspended particles in a process fluid of the light distribution that is emitted in the main emission direction and is in particular collimated.

The sensor device therefore measures the intensity of the light scattered by the suspended particles. Since this intensity is proportional to the concentration of suspended particles in the process fluid, the turbidity of the process fluid in the inner chamber in front of the sensor device can be determined therefrom. On the basis of the turbidity, a distinction can be made between different process media provided.

In some embodiments, the valve body comprises: at least one clamping section for abutting a lateral region of a shut-off body designed as a valve diaphragm, wherein the clamping section surrounds a seat opening intended for being closed by means of the valve diaphragm, and wherein the seat opening extends into the inner chamber of the valve body and to the valve seat.

In another aspect, the present disclosure provides a process valve comprising: the valve body according to the first aspect; a shut-off body, in particular a valve diaphragm, which, when the process valve is closed, presses on the valve seat of the valve body and blocks fluid from flowing through the process valve, and which, when the process valve is open, is lifted off the valve seat and allows the fluid to flow through the process valve; a drive for moving a valve stem, wherein the valve stem is mounted so as to be movable along an adjustment axis and moves the shut-off body.

In another aspect, the present disclosure provides a method for operating a process valve, the method comprising: operating at least one light source to generate light in response to a supplied actuation signal, wherein the light generated by the at least one light source is coupled through a light- and/or sound-transparent element into an inner chamber of a valve body of the process valve that is separated by the light- and/or sound-transparent element, and wherein the light- and/or sound-transparent element closes an opening that extends into the inner chamber of the valve body; and/or operating at least one sensor device to generate a sensor signal which represents at least one characteristic of incident light through the light- and/or sound-transparent element closing the opening, or a characteristic of incident light through another light- and/or sound-transparent element closing another opening of the valve body.

This advantageously makes it possible to radiate light into and/or to sense light in the inner chamber of the valve body.

In some embodiments, the sensor signal generated by the at least one sensor device comprises at least one digital image which represents at least a first portion of a wet-side surface of the shut-off body that is located in the field of view of the at least one sensor device.

It is therefore advantageously possible to take photographs, which can be evaluated by machine or by a person, of the wet side of the diaphragm, which is wetted by process fluid during normal operation, at least during operating phases in which the process valve is free of process fluid, without the process valve having to be dismantled.

In some embodiments, the method comprises: opening the process valve, wherein a shut-off body of the process valve, which delimits the inner chamber of the process valve, is at least partially lifted off the valve seat; and operating the at least one light source and simultaneously operating the at least one sensor device to ascertain the at least one digital image while the shut-off body is at least partially lifted off the valve seat.

A larger capturable part of the wet-side surface of the shut-off body thus advantageously lies within the field of view of the camera. In particular, this allows a sealing portion of the wet-side surface, or at least an adjacent part, to be captured by the sensor device. As a result, the sealing portion of the wet-side surface of the shut-off body, which is relevant for the closing function, can also be captured.

In some embodiments, the method comprises: operating the at least one light source to generate light that is coupled into the inner chamber of the valve body; operating, while the light generated by the at least one light source is being emitted into the inner chamber, the at least one sensor device to obtain the at least one digital image, in particular while the shut-off body is at least partially lifted off the valve seat, wherein the at least one sensor device receives incident light from the first part of the inner chamber that is separated by the light- and/or sound-transparent element, wherein the first part and a second part of the inner chamber are separated by a valve seat; operating, while the light generated by the at least one light source is being emitted into the inner chamber, a further sensor device to obtain at least one further digital image, in particular while the shut-off body is at least partially lifted off the valve seat, wherein the further sensor device receives incident light from the second part of the inner chamber that is separated by the light- and/or sound-transparent element.

The additional sensor device advantageously allows the wet-side surface to be evaluated from a different perspective, either by machine or by a person.

In some embodiments, the method comprises: closing the process valve, a shut-off body of the process valve moving onto a valve seat and dividing the inner chamber of the process valve into a first part of the inner chamber and a second part of the inner chamber; operating the at least one light source to generate light within a period of time after the process valve has closed, the at least one light source radiating the light therefrom into the second part of the inner chamber via a light- and/or sound-transparent disk which delimits a second part of the inner chamber; operating the at least one sensor device to generate the sensor signal which represents at least a light intensity as a characteristic of the light which enters the first part of the inner chamber through the light- and/or sound-transparent disk and is received by the sensor device, wherein the at least one sensor device is operated after the process valve has closed and during operation of the at least one light source to radiate light into the second part of the inner chamber; and ascertaining the closure quality of the process valve on the basis of the at least one light intensity.

The proposed method advantageously makes it possible to reliably sense whether the process valve closes securely or not. If the light intensity lies above a threshold value, it can be concluded that there is a sealing problem.

In some embodiments, the method comprises: ascertaining a first turbidity value for the process fluid on the basis of the sensor signal generated at a first point in time by the at least one sensor device; ascertaining a second turbidity value for the process fluid on the basis of the sensor signal generated at a second point in time after the first point in time by the at least one sensor device; and closing the process valve on the basis of the first turbidity value and on the basis of the second turbidity value, in particular when a difference between the first turbidity value and the second turbidity value exceeds a limit value.

The proposed method advantageously prevents losses during the phase separation of cleaning media. Instead, a precise distinction can be made between different media. This thus makes it possible to establish from what point in time a different medium flows through the process valve. This avoids having a safety buffer in which too much of the media is returned to the wastewater system instead of being stored in tanks for further cleaning processes. The cleaning fluid thus contains less of the process fluid actually provided, thereby reducing the consumption of cleaning fluid. The overall environmental characteristics of the process plant are thus improved.

In another application example, in dairies for example, in order to prevent product losses a precise phase separation of milk and water must be carried out when emptying installations. Conventionally, the separation process is carried out using a sight glass or by means of a timer. This means high product losses and also, in the case of manual switching, additional personnel costs and quality differences. The disclosed turbidity monitoring process can address one or more of these issues by targeted media separation on the basis of the first and second turbidity values.

In some embodiments, the method comprises: transmitting the at least one sensor signal and/or at least one parameter derived therefrom, by means of a communication interface, in particular to a mobile terminal and/or to a process controller.

In the field of process control, monitoring of the process valve can be advantageously improved.

If the mobile terminal is used, it is possible for operating personnel to evaluate on site the sensor signal or the parameter derived therefrom. In particular, any damage indicated can be evaluated with the aid of the two-dimensional digital image without the shut-off body having to be removed.

In a further aspect, the present disclosure provides a control unit for a process valve, the control unit being configured to execute the method described herein.

Further features and details are set forth in the following description, in which exemplary aspects of the present disclosure are described with reference to the drawings. The features described in the claims, the description, and the drawings can be used individually or in any suitable combination.

### BRIEF DESCRIPTION OF THE DRAWINGS

Further features and advantages of the present disclosure will be apparent from the following description of illustrative aspects of the present disclosure, which are explained below with reference to the figures. Like reference numerals refer to like and functionally corresponding elements throughout the drawings. In the drawings:

FIG. 1 shows a valve body in schematic form;

FIG. 2 shows an example of the valve body in schematic form;

FIG. 3 shows a further example of the valve body in schematic form;

FIG. 4 shows an example of the valve body in schematic form with two sensor devices and two light sources;

FIG. 5 shows a section of the valve body;

FIG. 6 shows a flowchart of a method;

FIG. 7 shows a flowchart of a different method;

FIG. 8 shows schematically represented digitally generated images from an inner chamber of the valve body, which were taken by means of the sensor device;

FIG. 9 shows a capture region on a valve diaphragm in schematic form;

FIG. 10 shows two capture regions on the valve diaphragm in schematic form;

FIG. 11 shows a flowchart of a different method;

FIG. 12 shows a flowchart of another different method;

FIG. 13 shows a different example of the valve body in schematic form;

FIG. 14 shows a section through a development of the valve body from FIG. 13;

FIG. 15 shows a flowchart of a method for measuring turbidity; and

FIG. 16 shows a schematic section through a light- and/or sound-transparent element arranged in an opening of the valve body;

FIG. 17 shows a perspective view of the valve body; and

FIG. 18 shows a process valve and a control unit in schematic form.

### DETAILED DESCRIPTION

As used herein, a “process fluid channel” can include any passage, bore, conduit, or channel of the valve body through which process fluid can flow.

An “inner chamber” can include an internal fluid-containing region of the valve body that is at least partially delimited by one or more process fluid channels and at least one valve seat, and can include first and second parts or subregions on opposite sides of the valve seat.

A “light- and/or sound-transparent element” can include any element that permits transmission of light and/or sound sufficient to enable illumination, sensing, imaging, monitoring, or measurement through the element, and need not be completely transparent for all wavelengths or frequencies.

A “sensor device” can include one or more sensors or sensor modules, alone or in combination, and a “sensor signal” can include raw or processed analog or digital data, including image data, intensity data, acoustic data, topography data, turbidity-related data, and derived parameters.

As used herein, a “shut-off body” can include a valve diaphragm, a plug diaphragm, or another valve-closing body configured to move relative to a valve seat to regulate or block fluid flow.

A “wet-side surface” can include a surface exposed to process fluid during normal operation. “Closure quality” can refer to a condition, state, or measure representative of the extent to which the process valve is closed and/or leakage is prevented or limited.

A “turbidity value” can include a value representative of optical scattering, transmission, suspended-particle concentration, or cloudiness of a process fluid, and can be expressed in nephelometric turbidity units or in another unit or relative value.

A “main emission direction” can include a predominant direction in which emitted light propagates into the inner chamber and does not require perfect collimation.

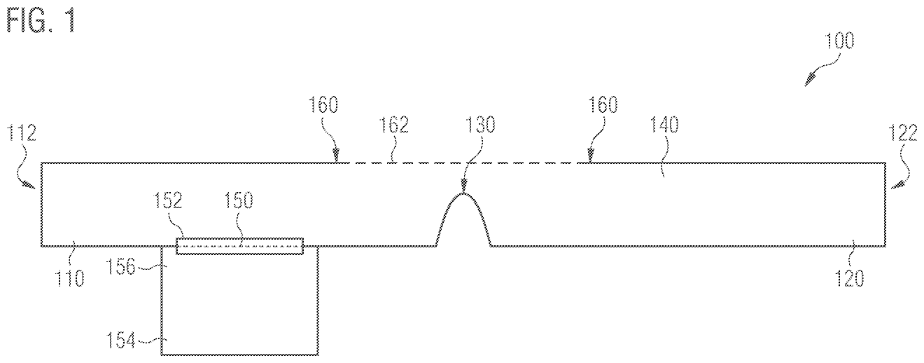

FIG. 1 is a schematic view of a valve body 100 for a process valve. The valve body 100 comprises at least two process fluid channels 110, 120, which extend from a respective process fluid port 112, 122, to at least one valve seat 130 of the valve body 100 and at least partially delimit an inner chamber 140 of the valve body 100 together with the valve seat 130. At least one opening 150, which extends into the inner chamber of the valve body, is closed by a light- and/or sound-transparent element 152.

The at least one opening 150 extends through a wall of the valve body 100 and is at a distance from the valve seat 130.

The element 152 closes the at least one opening 150. The element 152 has a surface that is designed for contact with process fluid and is associated with the process fluid channel 110, 120.

The surface of the element 152 associated with the process fluid channel 110, 120 is part of the inner surface of the associated process fluid channel 110, 120.

The surface of element 152 facing the associated process fluid channel 110, 120 partially forms an inner wall that delimits the associated process fluid channel 110, 120.

The aforementioned surface of the element 152 is flush with the adjacent inner wall of the valve body 100.

The light- and/or sound-transparent element 152 is preferably made of glass, in particular sapphire glass, borosilicate glass or quartz glass, wherein transparent plastics can alternatively also be considered as suitable materials. The light- and/or sound-transparent element 152 can also be referred to as a light- and/or sound-transparent disk, since a greater proportion of light rays pass through the element 152 (>50%) without being reflected within the element 152, for example at lateral surfaces.

The light transparency of the element 152 refers to the transmission of light in one or more wavelength ranges. The transmitted light can comprise wavelength ranges that are visible and/or not visible to humans.

The sound transparency of the element 152 refers to the transmission of sound in one or more wavelength ranges. The transmitted sound can include wavelengths that are audible or inaudible to humans.

An inner surface of the light- and/or sound-transparent element 152, together with an inner surface of a wall 102 of the valve body 100, delimits the inner chamber 140 of the valve body 100.

The opening 150 is formed in the non-light-transparent wall 102 of the valve body 100. The wall 102 has an inner surface which is in contact with the process fluid during operation of the process valve. The light- and/or sound-transparent element 152 comprises the inner surface which is in contact with the process fluid during operation of the process valve.

The opening 150 in the wall 102 is designed to receive the light- and/or sound-transparent element 152.

The wall 102 of the valve body is made, for example, from stainless steel, a fluoroplastic or another plastic.

The light- and/or sound-transparent element 152 makes possible the transmission of light across a broad spectrum, especially in the visible light range, but also ultraviolet (UV) and infrared (IR) light as well as other relevant wavelengths. It is assumed that the light impinging on the light- and/or sound-transparent element 152 exits to a sufficient extent on the opposite side so that any impairment of the original light intensity or characteristic is not of significant importance in the context of practical application.

The light- and/or sound-transparent element 152 is designed to retain its light-transparent and sealing properties even under considerable mechanical stress-especially under a pressure difference of several bar between the inner chamber 140 and the outer chamber of the valve body or the dry chamber 154 in which further optical units are located. The material and design of the element are therefore selected such that even under high pressure loads there is no significant change or impairment in terms of light transmission and at the same time tightness toward the outside is ensured.

The dry chamber 154 is, for example, optically sealed off from the outer chamber of the valve body by means of a wall 156 so that no outside light enters the dry chamber 154.

The valve body 100 comprises at least one clamping section 160 for abutting a lateral region of a shut-off body 200 designed as a valve diaphragm, wherein the clamping section 160 surrounds a seat opening 162 intended to be closed by means of the valve diaphragm, and wherein the seat opening 162 extends into the inner chamber 140 of the valve body 100 and to the valve seat 130.

If, however, the valve body 100 is intended for a different shut-off body, the clamping section 160 for the valve diaphragm is omitted. In the case of seat valves, for example, shut-off bodies can be moved within the inner chamber 140 together with part of the valve stem.

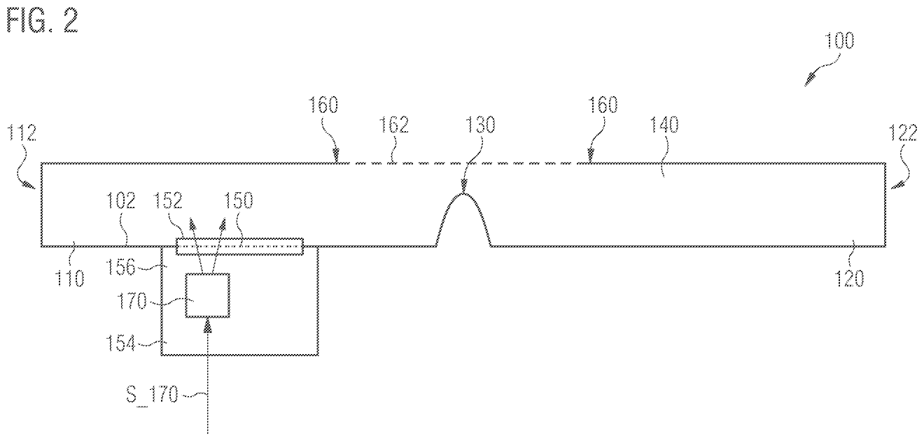

FIG. 2 shows in schematic form an example of the valve body 100. At least one light source 170 is arranged in the dry chamber 154, which is configured to generate light in response to a supplied actuation signal S_170 and to couple the light generated by the at least one light source 170 through the light-transparent element 152 into the inner chamber 140 of the valve body 100 that is separated by the light-transparent element 152.

In one example, the light emitted by the at least one light source 170 at least partially comprises UV-C light, in particular in the wavelength range of about 200 to 280 nanometers.

In another example, the at least one light source 170 produces light across a broad spectrum, in particular in the visible light range. In another example, the at least one light source 170 generates ultraviolet (UV) and/or infrared (IR) light.

The at least one light source 170 comprises, for example, at least one semiconductor light source.

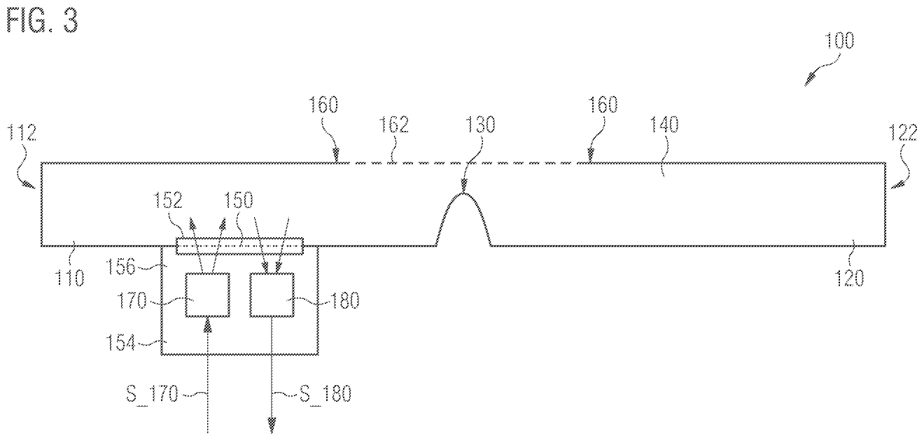

FIG. 3 shows in schematic form a further example of the valve body 100. At least one sensor device 180 is provided, which is configured to receive incident light from the inner chamber 140 that is separated by the light-transparent element 152 and to generate a sensor signal S_180, which represents at least one characteristic of the light impinging on the sensor device 180 through the light-transparent element 152.

In one example, it is provided that the at least one sensor device 180 is configured to detect at least some of the wavelength ranges of the light that is generated by the at least one light source 170 and emitted into the inner chamber 140 of the valve body 100 via the light-transparent element 152.

In the example shown, the at least one light source 170 is provided to couple light into the inner chamber 140. However, the light source 170 can also be arranged at another opening (not shown in FIG. 3) in order to prevent reflections and/or light being coupled into the sensor device 180.

The at least one sensor device 180 can comprise a photosensor that measures light intensity, for example as a photodiode, and/or an image sensor such as a camera with light sensors arranged in the form of a matrix, in order to obtain a two-dimensional digital image, in particular a color image.

The at least one sensor device 180 is therefore configured, for example, to capture a digital image of at least part of the wet-side surface of the installed valve diaphragm and thereby generate high-resolution image and surface data. The sensor device 180 comprises a single sensor module or a combination of a plurality of sensor modules, each designed for specific acquisition tasks and collectively making possible a comprehensive analysis of the wet-side surface of the valve diaphragm.

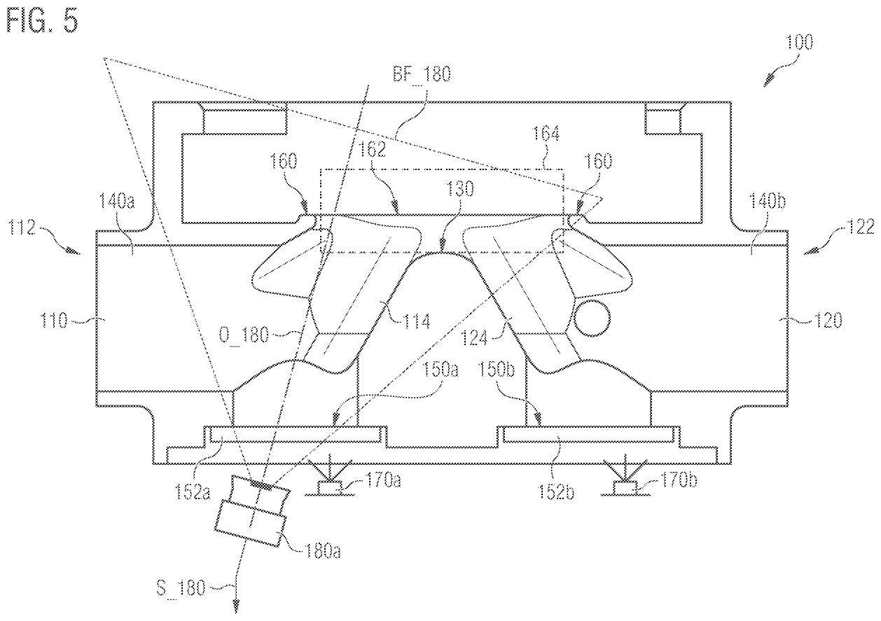

Depending on the size of the valve body 100, the wet-side surface of the valve diaphragm can be located at a distance of approximately 2 cm to 20 cm from the sensor device 180. The surface is captured through a tunnel-shaped portion of the process fluid channel, which restricts the geometry and angle with which the at least one sensor device 180 views the surface (see FIG. 5). The at least one sensor device 180 is designed to compensate for the physical limitations caused by limited visibility and the glass cover. Surface data is acquired with high resolution in the range of less than 0.1 mm, in particular in the range of 1-10 μm up to nanometer resolution, in order to reliably capture the smallest structures, such as cracks, folds and surface deformations.

The at least one sensor device 180a comprises at least one of the following sensor modules:
(1) Image sensor: The image sensor is capable of capturing high-resolution image data of the wet-side surface of the valve diaphragm. The image sensor comprises, for example, a telecentric lens with high depth of field and low distortion, which makes possible a sharp image of the wet-side surface of the valve diaphragm. The image sensor uses a CMOS or CCD sensor with a pixel size in the range of from 1-5 μm in order to capture the finest details of the wet-side surface of the valve diaphragm. An integrated adaptive polarization filter unit is used to compensate for reflections from the light-transparent element and improve signal quality. Automatic focus adjustment is achieved, for example, by a piezoelectric actuator that adjusts the focus to the variable distance from the surface (within the range of 2 cm to 20 cm). The image sensor captures two-dimensional surface data and makes possible a subsequent image analysis with the aid of artificial intelligence (AI). The AI-based analysis identifies and classifies surface defects such as cracks, wrinkles, and scratches. The image sensor preferably operates in the visible and/or near-infrared range (400 nm-1100 nm) to ensure high image quality even under difficult lighting conditions.
(2) Confocal sensor: The confocal sensor is based on point scanning and is designed to capture the topography of the wet-side surface of the valve diaphragm with high precision. The confocal sensor comprises a laser source (e.g. a red, blue or infrared laser) in the sense of the light source 170a and a chromatic lens system that makes it possible to separate the wavelength components of the reflected light. A spectrometer analyzes the wavelength shift of the reflected light and uses this to provide height information about the surface. The resolution of the confocal sensor ranges from 1-10 nm in the lateral direction and up to 10 nm in the axial direction. Point scanning is performed along a defined scan line or matrix and makes possible a highly precise acquisition of the surface topography. The confocal sensor detects microscopic structures, including fine cracks, folds, and irregularities on the wet-side surface. The chromatic splitting of the light makes reliable measurement through the glass pane possible without affecting signal quality as a result of refraction or reflection.
(3) Laser triangulation sensor: The laser triangulation sensor is designed to determine the height and structure of the wet-side surface of the valve diaphragm by triangulating the reflected laser beam. The sensor comprises a laser diode in the sense of the light source 170 a with a defined wavelength (e.g. 650 nm) and a CMOS sensor element for determining the position of the reflected laser beam. The distance from the wet-side surface of the valve diaphragm is determined from the deviation in the reflection position. An integrated polarization filter is used to suppress disturbing reflections from the light-transparent element and to optimize signal quality. The laser triangulation sensor operates with a resolution ranging from 1-10 μm and a sampling rate of up to 10 kHz, enabling fast and highly precise acquisition of the surface topography. The laser triangulation sensor is particularly suitable for detecting folds, cracks and surface irregularities on the wet-side surface of the valve diaphragm, even in the case of complex surface structures and varying surface reflections.
(4) Optical coherence tomography (OCT) sensor: The optical coherence tomography (OCT) sensor uses coherent infrared light to measure the three-dimensional depth of the wet-side surface of the valve diaphragm. The sensor operates with a resolution ranging from 1-10 μm and a penetration depth of up to 3 mm. The OCT sensor is able to detect internal material differences and even defects located below the surface. The measurement principle is based on an interferometric approach, in which the phase shift of the reflected light is analyzed to obtain depth and structural information. The OCT sensor is particularly suitable for the analysis of complex surfaces, multi-layered materials and deep-lying defects.
(5) Telecentric camera system: The telecentric camera system comprises a telecentric lens with a parallel beam path and a high-resolution CMOS or CCD sensor element. The telecentric lens creates a distortion-free image of the surface and delivers a large depth of field. The camera system is equipped with a reflection compensation lens to suppress reflections from the glass pane or the light-transparent element. The camera system delivers high-resolution two-dimensional image data and makes subsequent analysis possible using artificial intelligence. Cracks, folds and material transitions are automatically detected by separate image processing software.
(6) Lidar system: The lidar system is designed to record the three-dimensional structure of the wet-side surface of the valve diaphragm with high precision and speed. To detect the reflected signals the system uses a pulsed laser beam, for example with a wavelength in the visible or near-infrared range (e.g. 905 nm or 1550 nm), and a highly sensitive receiver, such as an avalanche photodiode (APD) receiver. The lidar system operates using the time-of-flight (ToF) principle, in which the transit time of the reflected laser pulse is measured in order to determine the distance from the surface with an accuracy in the range of from 10-100 μm. The laser beam is guided through a micromirror array or a rotating prism lens, resulting in high-resolution scanning of the entire wet-side surface of the valve diaphragm. The system's sampling rate is in the range up to 1 MHz, which makes fast recording possible even with complex surface geometries and moving objects. The lidar system is equipped with an adaptive polarization filter unit to compensate for disruptive reflections from the glass pane or light-transparent element and to maximize signal quality. The raw data collected are analyzed in real time by an embedded signal processing system. AI-based evaluation makes possible the precise detection and classification of surface defects such as cracks, folds, scratches and irregularities. The AI-based analysis takes into account surface topography patterns in order to detect even the smallest irregularities. The lidar system is particularly suitable for inspecting complex surface structures and regions with varying reflection intensity. Due to the high scanning rate and high lateral and axial resolution, the system is able to reliably detect even the smallest defects and shape deviations on the wet-side surface of the valve diaphragm.
(7) Hydroacoustic system: The at least sound-transparent element 152 is designed as a sound transmission unit such that sound waves are transmitted through the element 152 and into the inner chamber of the valve body and/or from the inner chamber of the valve body to the outside. A sound source located in the dry chamber is configured to send sound waves through the element 152. The aforementioned sensor unit is designed to receive sound waves through the element 152. The light- and/or sound-transparent element 152 is mechanically connected to the wall of the valve body, which ensures stable positioning and low-loss acoustic coupling between the element 152 and the wall of the valve body. The system is used for capturing material properties, defects, deposits or structural changes on the wet-side surface of the valve diaphragm when installed. The sensor device preferably operates in the frequency range of 500 kHz to 5 MHz in order to achieve high lateral and axial resolution. The system uses an adaptive signal processing unit that evaluates the received sound waves and compensates for any reflection, refraction and attenuation in order to maximize image quality. The sound source is designed as a phased array system, which allows the direction and focus of the emitted sound waves to be controlled electronically. This allows precise scanning of the wet-side surface of the valve diaphragm at different angles and depths. The hydroacoustic system allows continuous monitoring of the structure of the wet-side surface of the valve diaphragm and makes it possible to detect deposits, cracks, wall thickness changes and signs of corrosion. The received sound signals are processed, for example, by an AI-based analysis platform in order to identify and classify structural changes. The adaptive control of the sound focus allows dynamic adjustment to different internal geometries and material properties. The system is capable of generating a detailed three-dimensional representation of the wet-side surface of the valve diaphragm and capturing defects with a resolution in the submillimeter range.

The sensor device 180 makes possible the simultaneous, sequential or individual use of the various sensor modules in order to ensure comprehensive acquisition of the surface structure, topography and material properties. The combination of at least two of the following modules: image sensor, confocal sensor, laser triangulation sensor, coherence tomography sensor and telecentric camera system makes a more in-depth analysis possible of the wet-side surface of the valve diaphragm with a resolution in the submicrometer range.

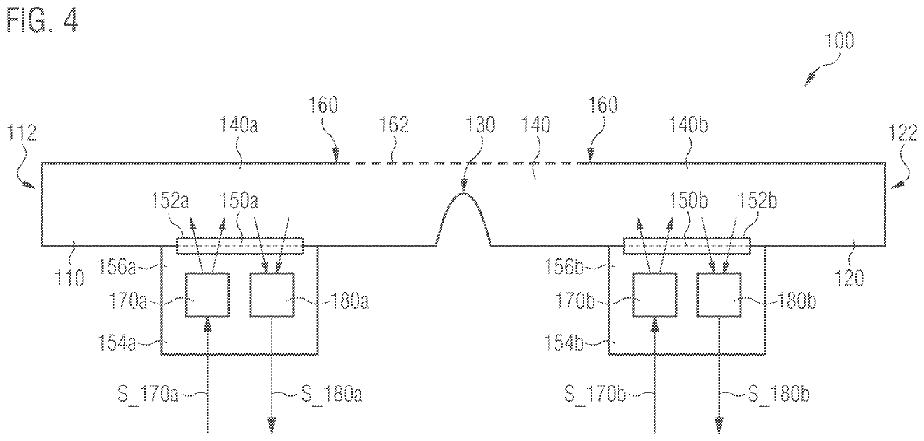

FIG. 4 shows another example of the valve body 100 in schematic form. A plurality of openings 150a-b that are at a distance from one another are provided, each extending into the inner chamber 140 of the valve body 100. Each of the openings 150a-b is closed by an associated light- and/or sound-transparent element 152a-b.

A plurality of light sources 170a-b are provided and designed to generate light in response to an actuation signal S_170a-b, each of which are in particular supplied individually, and to couple the light generated by each light source 170a-b into the inner chamber 140 of the valve body 100 through a different light- and/or sound-transparent elements 152a-b of the plurality of light- and/or sound-transparent elements.

A plurality of sensor devices 180a-b are provided and designed to receive incident light from the inner chamber 140 that is separated by the associated light and/or sound-transparent elements 152a-b and to generate a respective sensor signal S_180a-b, which represents the at least one characteristic of the incident light through the associated light and/or sound-transparent element 152a-b and/or represents at least another characteristic of the incident light through the associated light and/or sound-transparent element 152a-b.

In this example, it is shown that the valve seat 130 of the valve body 100 divides the inner chamber 140 into a first part 140a and a second part 140b, in particular into the first and second process fluid channels 110, 120, wherein a first of the openings 150a extends into the first part 140a of the inner chamber 140, and wherein a second of the openings 150b extends into the second part 140b of the inner chamber 140.

In a more detailed specification, it is provided that the at least one sensor device 180a or the plurality of sensor devices 180a-b is/are designed to generate at least one digital image representing a state of at least part of the inner chamber 140 of the valve body 100, as well as the at least one characteristic in the form of the at least one sensor signal S_180 or in the form of the respective one of the plurality of sensor signals S_180a-b.

The at least one light- and/or sound-transparent element 152 and the associated at least one sensor device 180 are arranged such that the opening 162 is in the field of view of the at least one sensor device 180.

In another example (not shown), the at least one light- and/or sound-transparent element 152 and the associated at least one sensor device 180 are arranged such that the opening 162 is not in the field of view of the at least one sensor device 180.

FIG. 5 shows a section through the valve body 100 in FIG. 4, with only one of the plurality of sensor devices 180a being shown for the sake of clarity. A region 164 of the valve body 100, in which a shut-off body 200 moves to open and close the process valve 2 during operation of the process valve 2, at least lies partially in a field of view BF_180 of the at least one or of each sensor device 180. In order to illuminate the shut-off body in the region 164, the at least two or only one of the light sources 170a and 170b is/are operated to emit light, for example.

An optical axis O_180 of the at least one sensor device 180a-b or of the respective one of the plurality of sensor devices 180a-b runs not only through a portion 114, 124 of a process fluid channel 110, 120, which connects a process fluid port 112, 122 and the seat opening 162 to one another, but also through the seat opening 162.

The light- and/or sound-transparent element 152a-b is arranged in the associated portion 114, 124 of the process fluid channel 110, 120 on a side of the valve body 100 facing away from the seat opening 162.

The at least one sensor device 180a-b is therefore arranged such that the associated optical axis O_180 follows the course of the portion 114, 124 of an imaginary central longitudinal axis of the respective portion 114, 124 of the process fluid channel 110, 120, which can also be understood as a tilting movement of the optical axis O_180 relative to the central longitudinal axis of the respective portion 114, 124, as shown. That is to say, the optical axis O_180 is aligned at a predetermined angle relative to the normal of the opening of the portion 114, 124 defined by the opening 162 and the valve seat 130.

A mount (not shown) for the at least one sensor device 180a connects the valve body 100 and the sensor device 180a and is designed such that the position of the at least one sensor device 180a relative to the valve body 100 is fixed in such a way that the at least one sensor device 180a and in particular its field of view is oriented to the wet-side surface of the valve diaphragm.

The at least one sensor device 180a is therefore arranged such that the optical axis O_180a of the at least one sensor device 180a is directed through the portion 114 onto the wet-side surface of the valve diaphragm, wherein the orientation of the sensor device 180a is set such that the region recorded by the at least one sensor device 180a covers at least part of the wet-side surface of the shut-off body 200 visible from the portion 114.

Each portion 114, 124 of the process fluid channel 110, 120 extends in a first direction to the valve seat 130. The portion 114, 124 of the process fluid channel 110, 120 extends in a second direction counter to the first direction to the light- and/or sound-transparent element 152a-b that closes the at least one opening 150a-b. In the dry chamber, the at least one sensor device 180a-b is arranged such that light rays, for example, which travel from the wet-side surface of the valve diaphragm, through the portion 114, 124 and in the direction of the light- and/or sound-transparent element 152, are received by the sensing surface of the at least one sensor device 180a and converted into the sensor signal.

The at least one sensor device 180a-b is designed according to one of the examples explained with reference to FIG. 3.

The arrangements shown in FIGS. 3 to 5 each consist of at least two structurally and functionally separate elements, namely the at least one light- and/or sound-transparent element 152a-b and the opening 162, which are spaced apart from one another by the tunnel-like portion (provided with reference numerals 114, 124 in FIG. 5). The at least one light- and/or sound-transparent element 152a-b and the opening 162 are positioned such that a straight geometric connection exists between them, which is referred to as the visual axis and extends through the tunnel-like portion.

The visual axis is an imaginary line that establishes the optical connection between the light- and/or sound-transparent element 152a-b and the opening 162. This visual axis extends along the longitudinal axis of the tunnel-like portion and is, for example, aligned such that the central point of the disk is coaxial with an off-center point of the opening 162. The disk and the opening 162 are thus located on a common optical axis, which allows a direct visual view from the disk through the opening 162.

The tunnel-like portion is delimited by inner walls and extends from the at least one light- and/or sound-transparent element 152a-b toward the valve seat 130.

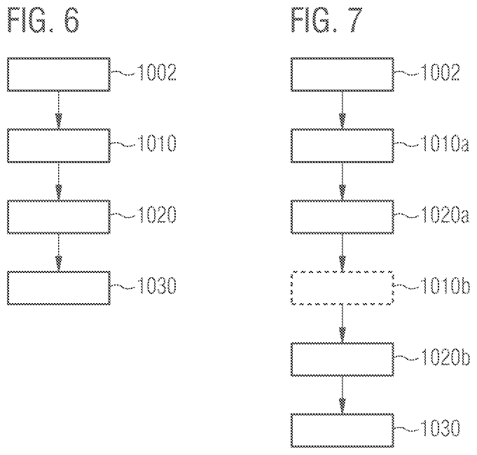

FIG. 6 shows an exemplary method for operating the valve body 100 or the associated process valve. According to this example, the process valve is opened 1002 insofar that it is still closed, wherein the shut-off body of the process valve, which delimits the inner chamber of the process valve, is at least partially lifted off the valve seat.

The method comprises operating 1010 the at least one light source to generate light in response to a supplied actuation signal, wherein the light generated by the at least one light source is coupled through the at least one light- and/or sound-transparent element into the inner chamber of the valve body of the process valve that is separated by the light- and/or sound-transparent element, and wherein the light- and/or sound-transparent element closes the opening extending into the inner chamber of the valve body.

At the same time as the at least one light source is operated 1010, the at least one sensor device is operated 1020 to generate the sensor signal, which represents the at least one characteristic of the incident light through the light- and/or sound-transparent element that closes the opening, or another characteristic of the incident light through the further light- and/or sound-transparent element that closes a further opening of the valve body.

In one example, the sensor signal generated by the at least one sensor device at least comprises the one digital image which represents at least a first portion of a wet-side surface of the shut-off body located in the field of view of the at least one sensor device. Performing steps 1010 and 1020 simultaneously allows the at least one digital image to be captured while the shut-off body is at least partially lifted off the valve seat.

FIG. 7 shows another method for operating the valve body or the associated process valve. The at least one light source is operated 1010a to generate light which is coupled into the inner chamber of the valve body.

Furthermore, while the light generated by the at least one light source is radiated into the inner chamber, the at least one sensor device is operated 1020a to obtain the at least one digital image, in particular while the shut-off body is at least partially lifted off the valve seat, wherein the at least one sensor device receives incident light from the first part of the inner chamber that is separated by the light- and/or sound-transparent element, and wherein the first part and a second part of the inner chamber are separated by a valve seat.

Furthermore, while the light generated by the at least one light source is radiated into the inner chamber, the further sensor device is operated 1020b to obtain at least one further digital image, in particular while the shut-off body is at least partially lifted off the valve seat, wherein the further sensor device receives incident light from the second part of the inner chamber that is separated by the light- and/or sound-transparent element.

In an optional step 1010b, a light source different from the one in step 1010a is operated. In step 1010a, the light source which couples the light therefrom into the second part in order to radiate light from the side of the inner chamber 140 that is opposite the valve seat onto the shut-off body, i.e. into the first part in which the first sensor device captures or acquires the image, is operated. Accordingly, in step 1010b, the light source which couples its light into the first part is operated such that the further second sensor device in the second part captures the image from there.

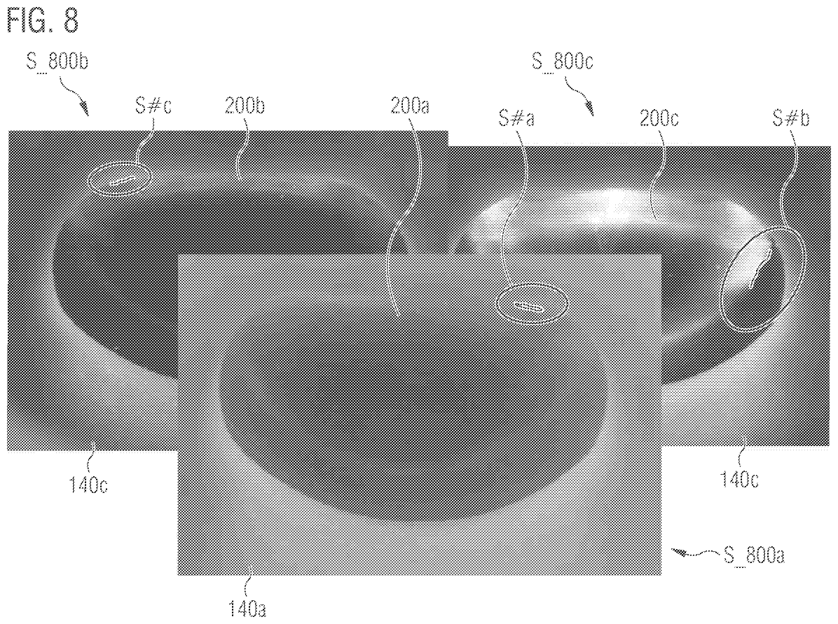

FIG. 8 shows, by way of example, the digital images according to the respective sensor signal S_180a-c or according to a section of the respective image, which were generated according to the method according to FIG. 6 or 7 or with the valve body from FIG. 4 or 5. In this process, an image was captured by the sensor device via the first part of the inner chamber of the valve body and the illumination of the shut-off body 200a-c, in this case a valve diaphragm, was provided via the second part.

According to the image of the sensor signal S_800a, an element of damage S #a is visually recognizable, which includes a superficial crack in or near the sealing region of the shut-off body 200a.

According to the image of the sensor signal S_800b, an element of damage S #b is visually recognizable, which also includes a superficial crack near the sealing region of the shut-off body 200b. In comparison to the element of damage S #a, the crack is located in a different place.

According to the image of the sensor signal S_800c, an element of damage S #c is visually recognizable, which indicates damage in the region of the flexing region.

The elements of damage shown as examples can be assessed by a person to whom the images are provided. Additionally or alternatively, the elements of damage are classified by a machine-trained function into defect classes such as ‘no surface defect’, ‘serious surface defect in the seat region’, ‘minor surface defect in the seat region’.

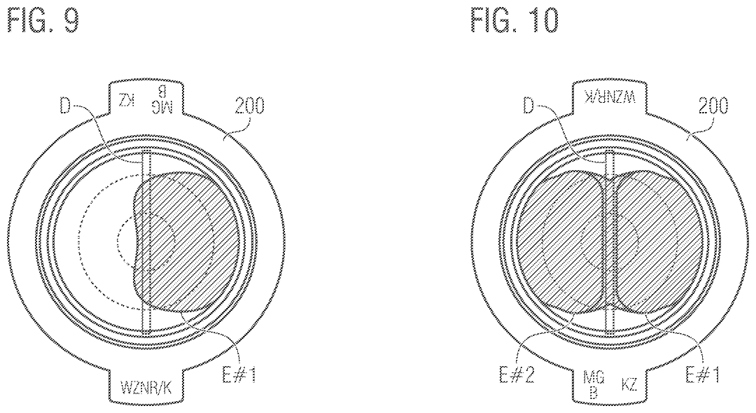

FIGS. 9 and 10 illustrate the acquisition region of the sensor devices in FIGS. 3 to 8 and their description. Both figures show a plan view of a wet side of the shut-off body 200 designed as a valve diaphragm. FIG. 9 shows an acquisition region E #1 on the wet-side diaphragm surface, which is captured, for example, by an image generated by a single sensor device from FIG. 5. In addition, the valve diaphragm must be open. Advantageously, a large proportion of a sealing portion D, which presses on the valve seat when closed, is captured.

FIG. 10 shows two acquisition regions E #1 and E #2 on the wet-side surface of the valve diaphragm or the shut-off body 200, which are in each case captured as part of a digital or digitally generated image, which was taken from different parts of the inner chamber by one of the sensor devices. The acquisition regions E #1 and E #2 overlap in the region of the sealing portion D.

The acquisition regions E #1 and E #2 can be fused by means of the two associated images to generate a common image of the wet-side surface of the valve diaphragm. However, the images that comprise the acquisition regions E #1 and E #2 can also be classified separately by machine or by a person.

The acquisition regions shown are only examples and are not limited to the region shown. The region can also be enlarged to capture the entire diaphragm, depending on the camera angle and the size of the window.

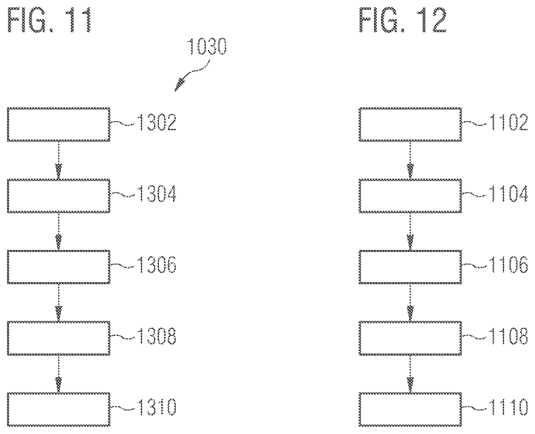

FIG. 11 shows a schematic flowchart that by way of example specifies step 1030 from FIGS. 6 and 7 in more detail. In this development of the method according to a step 1030, in a step 1302, the digital image, which is provided in the form of the at least one sensor signal by the at least one sensor device, is preprocessed and the region showing the shut-off body or the surface thereof is sent to damage detection.

In step 1302, the captured image is consequently subjected to preprocessing, which includes steps such as noise reduction, contrast adjustment, color correction and/or sharpening to optimize image quality and minimize interference.

Using at least one image segmentation method, in step 1304, the region in the digital image that comprises the surface of the shut-off body or valve diaphragm to be analyzed is identified. Optionally, the camera or the camera's field of view is calibrated in advance to precisely locate and align the relevant region, e.g. by geometric transformations.

In step 1306, characteristic features such as crack patterns, color deviations, and texture irregularities of the segmented image are analyzed by means of a method. Using image processing methods, e.g. edge or contour detection, and/or advanced methods such as deep learning, e.g. convolutional neural networks (CNN), anomalies such as the crack patterns mentioned by way of example are detected, which indicate visible damage to the shut-off body or diaphragm.

Any damage or anomaly detected in step 1306 is then categorized in step 1308, e.g. crack, fold, corrosion, protrusion, and assessed with regard to its severity. Threshold values, statistical models or neural networks can be used for classification.

The at least one anomaly categorized in step 1308 is marked in the digital image in a subsequent step 1310. The analyzed image is therefore output, for example with regions of damage marked, wherein the type and intensity of the damage is highlighted and/or provided in a readable textual and/or machine-readable format.

In another example of step 1310, an automated report is generated that documents the identified damage, its location, size and severity.

In one version, the system can contain a feedback loop in which the process owner or maintenance personnel validates the result of step 1310 in order to generate training data therefrom and to thus continuously improve the model, e.g. through reinforcement learning or continuous training.

FIG. 12 shows a schematic flowchart of a method. This method can be used to identify and monitor whether the process valve is closing securely, i.e. whether the shut-off body is moving reliably onto the associated valve seat and thus moving the process valve into a closed position to block the flow of process fluid.

Planned closure 1102 of the process valve takes place, wherein a shut-off body of the process valve moves onto a valve seat and divides the inner chamber of the process valve into a first part of the inner chamber and a second part of the inner chamber.

If the process valve is in the expected closed position, the at least one light source is operated 1104 to generate light for a period of time after the process valve has closed, wherein the at least one light source radiates the light therefrom into the second part of the inner chamber via a light- and/or sound-transparent disk which delimits a second part of the inner chamber.

While light is being coupled into the first part of the inner chamber, the at least one sensor device is operated 1106 to generate the sensor signal, which represents at least one instance of light intensity as a characteristic of the light which enters through the light- and/or sound-transparent disk from the first part of the inner chamber and is received by the sensor device. A digital image can also be captured and evaluated. That is to say, the at least one sensor device is operated after the process valve has closed and during operation of the at least one light source to radiate light into the second part of the inner chamber.

Depending on the sensor signal, and in particular depending on the light intensity represented by the sensor signal, a closure quality of the process valve is ascertained at 1108.

It is provided that high closure quality will be ascertained if a low degree of light intensity is identified, and that low closure quality will be ascertained if a high degree of light intensity is identified that is above the low degree of light intensity, i.e. above a limit value. It is assumed here that under normal conditions no light is incident in the inner chamber of the valve body.

If a high degree of light intensity is identified, in particular in the sealing region of the shut-off body or in the region of the valve seat, this indicates, when the process valve is closed as desired, that the light from the light source is passing from the second part into the first part. This can be for various reasons. Either the drive is not working, or there can also be damage to the shut-off element or the valve seat, creating an opening between the valve seat and the shut-off body through which the light from the light source passes from the second part of the inner chamber into the first part of the inner chamber. In addition, a disruptive body in the process valve can also ensure that a closing process cannot be carried out or cannot be carried out completely.

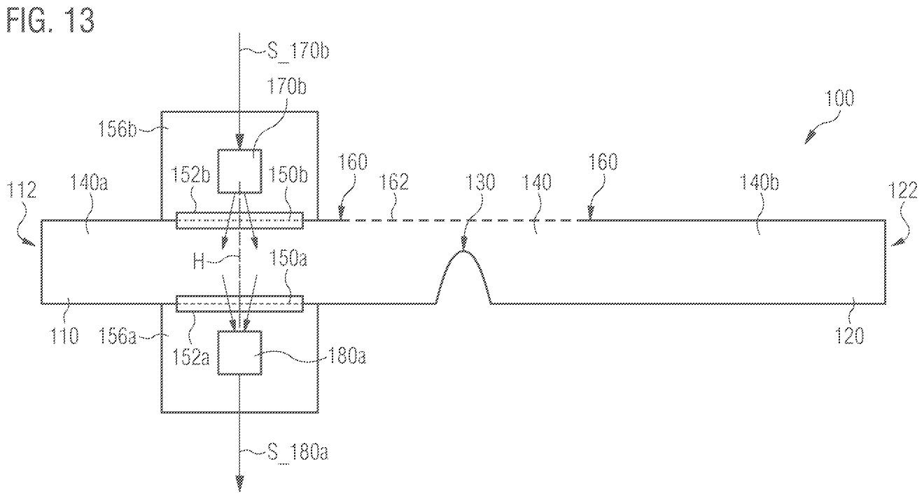

FIG. 13 shows in schematic form another example of the valve body 100 for measuring the turbidity of the process fluid provided. The at least one light source 170b, together with a first associated light- and/or sound-transparent element 152b of the plurality of light- and/or sound-transparent elements, is designed to couple light, in particular monochromatic light in the form of a light distribution, in particular a collimated light distribution, into the inner chamber 140 of the valve body 100 in a main emission direction H.

The at least one sensor device 180a, together with a second associated light- and/or sound-transparent element 152a of the plurality of light- and/or sound-transparent elements, is designed to capture at least one degree of light intensity of light scattered by suspended particles in the process fluid of the light distribution collimated in the main emission direction H.

According to the example shown in FIG. 13, the at least one light source 170b and the at least one sensor device 180a are arranged on opposite sides of the first process fluid channel 110, which is separated from the second process fluid channel 120 by the valve seat 130. Alternatively or additionally, the sensor device 180a can also be arranged at a different angle to the main emission direction H.

The at least one sensor device 180a is preferably oriented such that the main emission direction H passes through the field of view thereof.

Turbidity is measured in nephelometric turbidity units (NTU). NTU refers to the intensity of light scattered at an angle of 90°, measured relative to a standardized reference.

For example, the intensity is ascertained by the sensor device 180a in watts per square meter, W/m².

By performing a preliminary calibration with a standardized reference solution, the sensor signal ascertained by the sensor device is related to a reference value. In the process, the light scattering intensity of the reference solution is defined to correspond to a value of 1 NTU.

A so-called formazin solution is used as the reference solution. This suspension has a reproducible particle size distribution and concentration. These properties ensure that the optical scattering properties—and thus the measured turbidity—are stable and can be compared later on by means of measurements.

The NTU values are each obtained as a dimensionless, relative value that makes possible the comparison with the reference solution. That is to say, by definition, 1 NTU corresponds to the optical scattering produced by the standardized formazin solution.

The turbidity TR of the process fluid, which flows through the inner chamber 140 of the valve body 100 during valve operation, is obtained, for example, as follows:

TR=(I_Probe−I_Blank)/(I_Formazin−I_Blank)×T_Formazin
wherein
I_Probe: The light intensity measured by the sensor device at the sample, i.e. during the measurement process with the process fluid flowing past the light- and/or sound-transparent element.
I_Blank: The light intensity that was received as a blank signal during calibration, for example with clear water.
I_Formazin: The light intensity ascertained when measuring the standardized formazin solution during calibration.
T_Formazin: The nominal value of the standard formazin solution used, in NTU. For example, 1 NTU is used as a basis for this.

The standardization ensures that the light intensity signal ascertained by the at least one sensor device 180a is converted into a standardized, dimensionless value, i.e. NTU, which allows different measurement results to be compared.

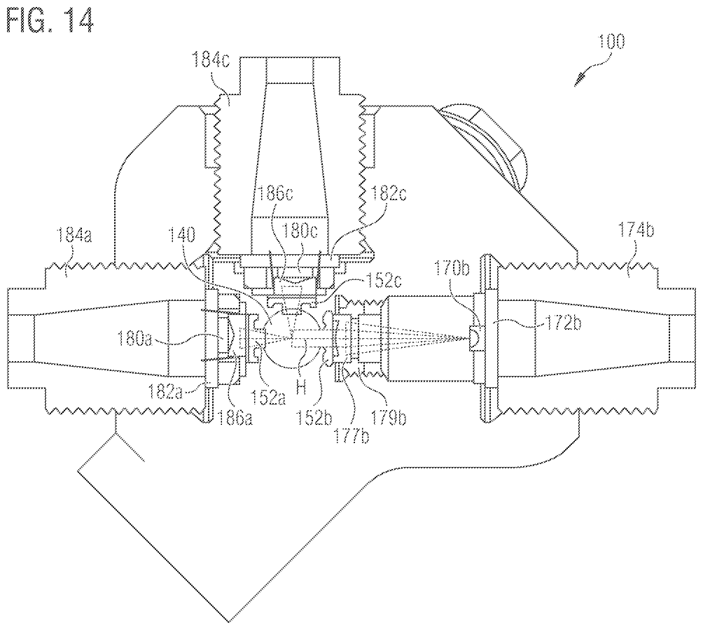

FIG. 14 shows a section of another example of the valve body 100 as a development of the valve body 100 shown schematically in FIG. 13. The at least one light source 170b is designed in the present case as a semiconductor light source arranged on a circuit board 172b. The circuit board 172b is fastened to the valve body 100 by means of a screw-in sleeve 174b, wherein the external thread of the screw-in sleeve 174b engages with an internal thread of the valve body 100 and presses outer portions of the circuit board 172b onto a counter-bearing portion of the valve body 100.

The light- and/or sound-transparent element 152b comprises a raised portion which extends through the associated opening in the valve body 100a via a tapered portion. The tapered portion is inserted, for example by means of an interference fit, into the corresponding opening of the valve body, which extends into the inner chamber of the valve body 100.

In the present case, a collimation lens 177b is arranged between the light- and/or sound-transparent element 152b and the fastening means 179b in order to transform the primary light distribution emitted by the at least one light source 170b into a collimated secondary light distribution which is radiated into the inner chamber 140 of the valve body 100. The collimation lens 177b is designed as a collimating lens.

The collimation lens 177b is pressed onto a counter-bearing, in this case onto the light- and/or sound-transparent element 152b, by means of a fastening force and thus fastened. The fastening force is applied by a fastening element 179b screwed into the valve body 100, which is designed, for example, as a fastening ring.

The sensor device 180a-c is designed in this case as a light sensor arranged on a circuit board 182a-c. The circuit board 182a-c is fastened to the valve body 100 by means of a screw-in sleeve 184a-c, wherein the external thread of the screw-in sleeve 184a-c engages with an internal thread of the valve body 100 and presses external or lateral portions of the circuit board 182a-c or structures arranged on the circuit board 182a-c onto a counter-bearing portion of the valve body 100.

An auxiliary lens 186a, 186c is arranged between the sensor device 180a-c and the associated light- and/or sound-transparent element 152a-c, which closes the opening extending into the inner chamber 140 of the valve body 100. The auxiliary lens transforms incident light passing through the associated light- and/or sound-transparent element 152a-c so that the light impinges on the associated sensor device 180a-c in accordance with a desired image.

The sensor device 180a is arranged on the axis belonging to the main emission direction H and thus looks directly into the light emitted by the at least one light source 170b.

The sensor device 180 c is arranged with its main viewing direction at 90°to the axis belonging to the main emission direction H and thus does not look directly at the light emitted by the light source 170b. It is rather the case that the medium to be measured flows perpendicularly to the plane of the drawing within the inner chamber 140.

The light- and/or sound-transparent element 152a-c comprises the raised portion which extends through the associated opening in the valve body 100 by means of a tapered portion. The tapered portion is inserted, for example by means of a press fit, into the associated opening of the valve body, which extends into the inner chamber 140 of the valve body 100. Of course, other ways of fastening the light- and/or sound-transparent element 152a-c in the associated opening of the valve body 100 are also conceivable.

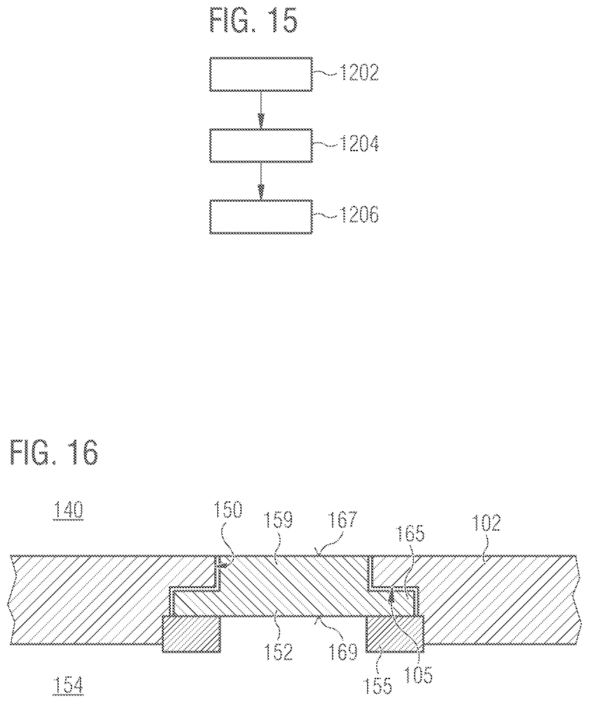

FIG. 15 shows a schematic flowchart in which the turbidity of the process fluid is ascertained and can thus be monitored. For this purpose, at least a first turbidity value is initially ascertained 1202 for the process fluid flowing through the inner chamber of the valve body when the process valve is open on the basis of the sensor signal generated at a first point in time by the at least one sensor device. At least a second turbidity value for the process fluid flowing through the inner chamber of the valve body when the process valve is open is ascertained 1204 on the basis of the sensor signal generated by the at least one sensor device at a second later point in time than the first point in time.

In particular, at the first point in time a first scattered light turbidity value is ascertained by means of the sensor device 180c according to FIG. 14 and a first scattered light turbidity value is ascertained by means of the sensor device 180a according to FIG. 14. At the second point in time a second scattered light turbidity value is ascertained by means of the sensor device 180c according to FIG. 14 and a second scattered light turbidity value is ascertained by means of the sensor device 180a according to FIG. 14. Two measurement methods (scattered light and transmitted light) are combined in one evaluation method, thus enabling high and low degrees of turbidity to be measured in one.

The measurement can advantageously accurately detect phase transitions between different media. This also allows the process valve to be correspondingly precisely actuated in order to selectively control the flow of a process medium.

The process valve is therefore opened or closed 1206 depending on the at least one first turbidity value and depending on the at least one second turbidity value, in particular as soon as a difference between the first turbidity value and the second turbidity value exceeds a limit value for at least a predetermined or variable period of time.

For example, if a phase transition from one process medium to another is detected in a main channel of a valve block, a valve region can be selectively opened to direct, for example flushing medium, from a tank into the main channel.

If, in another example, a different phase transition from one process medium to another is detected, the associated valve region can be selectively closed to prevent, for example, contamination by the subsequent flushing medium.

FIG. 16 shows a schematic section of another example of the arrangement of the light- and/or sound-transparent element 152 in the associated opening 150 of the wall 102 of the valve body 100.

The light- and/or sound-transparent element 152 separates the inner chamber 140 of the valve body 100, which is designed for the passage of process fluid, from the dry chamber 154 of the valve body 100. The wall 102 of the valve body 100 is made, for example, of stainless steel or a non-light-transparent plastic, which allows the light- and/or sound-transparent element 152 to allow light to pass from the dry chamber 154 into the inner chamber 140 and from the inner chamber 140 into dry chamber 154.

An annular fastening element 155 engages by means of its external thread with an internal thread of the wall 102 and exerts a fastening force on a lateral outer flange 165 of the light and/or sound-transparent element 152. The lateral outer flange 165 is thus pressed by the fastening element 155 against a counter-bearing portion 105 of the wall 102 and thereby fastens the light- and/or sound-transparent element 152 to the wall 102.

The surface 167 of the element 152 facing the inner chamber 140 and a surface 169 facing away from the inner chamber 140, i.e. toward the dry chamber 154, are plane-parallel to one another, in particular to minimize optical influences, especially unwanted light refractions, on light passing through the light- and/or sound-transparent element 152.

The raised portion 159 of the light- and/or sound-transparent element 152 is arranged in a region of the opening 150, which opening is tapered with respect to a portion of the opening 150 arranged in the direction of the dry chamber 154.

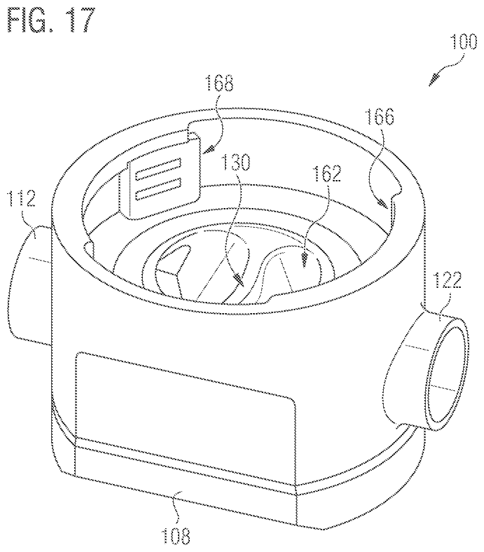

FIG. 17 shows a perspective view of an example of the valve body 100. On the side of the seat opening 162, which extends to the valve seat 130, an interface 166 is provided for connecting a drive or an intermediate body. The interface 166 comprises mechanical fastening elements, in this case bayonet-like tracks, in which a counterpart of a drive or intermediate body engages.

The interface 166 comprises an electrical interface 168, which provides an electrically conductive connection to the at least one sensor device and/or to the at least one light source. For example, the interface, represented here by four contacts, which provides a combined interface for the transmission of power and control or measurement data. Only two of the four contacts are visible in the illustration, since the other two are offset by 180°. Two contacts are provided for supplying power and the other two contacts are provided for communication.

The at least one sensor device and/or the at least one light source is/are arranged in the dry chamber of the valve body 100, which is closed by a cover 108. According to the previous examples, the cover 108 is part of the wall 156, e.g. in FIG. 1.

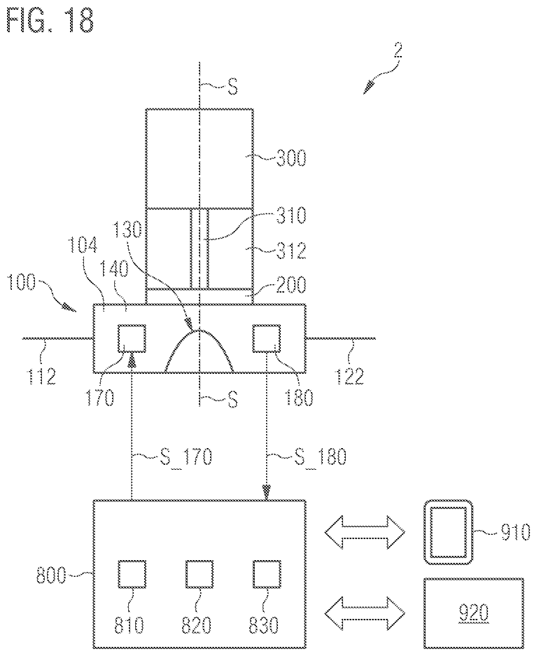

FIG. 18 is a schematic view of the process valve 2 for setting and/or controlling a flow of process fluid, which, when the process valve 2 is open, flows through the inner chamber 140 of the valve body 100 between the process fluid ports 112, 122. When the shut-off body 200 is pressed onto the valve seat 130, the flow of process fluid is interrupted.

The drive 300 is either directly connected to the valve body 100 or connected to the valve body 100 via an intermediate body 312.

The shut-off body 200 is, for example, a valve diaphragm, a plug diaphragm or some other kind of shut-off body. When the process valve 2 is closed, the shut-off body presses against the valve seat 130 and blocks fluid from flowing through the process valve 2. When the process valve 2 is open, the shut-off body 200 lifts off the valve seat 130 and allows the fluid to flow through the process valve 2.

The drive 300 is designed to move a valve stem 310 and is an electrically, pneumatically, fluidically or manually driven drive 300. The valve stem 310 is mounted so as to be movable along an adjustment axis S and the drive 300 moves the shut-off body 200 by means of the valve stem 310.

In addition, a control unit 800 is shown, which comprises at least one processor 810, at least one memory unit 820, and at least one communication interface 830. The methods disclosed in this description are stored as a computer program code in the at least one non-volatile memory unit 820 and are executable on the at least one processor 810.

The communication interface 830 is designed to transmit the at least one sensor signal S_180 and/or at least one parameter derived therefrom, in particular to a mobile terminal 910 and/or to a process controller 920.

In one example, the control unit 800 is integrated into the process valve 2 and performs some or all of the method steps described.

In another example, the control unit 800 receives commands from the mobile terminal 910 or the process controller 920 via the communication interface 830 and controls the drive 300 according to the commands received.

The control unit 800 executes the methods performed in this description independently or after activation by a higher-level unit, i.e. by the process controller 920 or the mobile terminal 910.

The at least one processor 810 is configured to execute program instructions stored in the at least one memory unit 820 to perform at least the following operations: generating the actuation signal to operate the at least one light source and/or sound source; receiving and processing the sensor signal from the at least one sensor device, including digitizing image data and computing turbidity values; comparing turbidity values or light intensity values against stored threshold values; generating drive commands to open or close the process valve based on the comparison; executing image preprocessing operations including noise reduction, contrast adjustment, and segmentation; and transmitting sensor signals, digital images, derived parameters, and status information via the communication interface 830. The at least one processor 810 can include, for example, a microcontroller, a digital signal processor, a field-programmable gate array, or a combination thereof. The at least one memory unit 820 can include non-volatile memory such as flash memory or EEPROM for storing the program instructions and calibration data, and volatile memory such as SRAM for temporary data processing.

The disclosed valve bodies, process valves, methods, and control units can, in various implementations, permit inspection or monitoring of an internal region of a valve body without disassembly, support evaluation of a wet-side surface of a shut-off body, support determination of valve closure quality, and/or support determination of one or more characteristics of a process fluid, such as turbidity. In some implementations, these features can facilitate maintenance planning, reduce downtime, improve process monitoring, improve media separation, and reduce product or cleaning-fluid losses. However, particular implementations may provide different advantages, and no particular advantage is required unless expressly recited in a claim.

The disclosed subject matter has been described above with reference to the examples shown in the figures. However, the disclosed subject matter is not restricted to the above examples but can vary within the scope of the claims. To the extent not already described, the different features and structures of the various aspects can be used in combination with, or substituted for, one another as desired. The fact that one feature is not illustrated in all aspects should not be construed to mean that it cannot be so illustrated, but rather is done for brevity of description. Thus, the various features of the different aspects can be mixed and matched as desired to form additional aspects, whether or not such aspects are expressly described. All combinations and permutations of features described herein are intended to be within the scope of this disclosure.

Persons skilled in the art will understand that the structures and methods specifically described herein and shown in the accompanying figures are non-limiting exemplary aspects, and that the description and figures should be construed merely as illustrative of such aspects. Accordingly, the present disclosure is not limited to the precise aspects described, and various other changes and modifications can be effected by one skilled in the art without departing from the scope of the present disclosure.

Additionally, the elements and features shown or described in connection with certain aspects can be combined with the elements and features of other aspects without departing from the scope of the present disclosure, and such modifications and variations are also included within the scope of the present disclosure. Accordingly, the subject matter of the present disclosure is not limited by what has been particularly shown and described.

What is claimed:

1. A valve body for a process valve, the valve body comprising:
at least two process fluid channels extending to at least one valve seat of the valve body and at least partially delimiting, together with the at least one valve seat, an inner chamber of the valve body; and
at least one opening arranged at a distance from the at least one valve seat, extending into one of the at least two process fluid channels of the inner chamber of the valve body, and closed by a light- and/or sound-transparent element,
a surface of the light- and/or sound-transparent element facing the one of the at least two process fluid channels partially forming an inner wall delimiting the one of the at least two process fluid channels.

2. The valve body of claim 1, further comprising:
at least one light source configured to generate light in response to a supplied actuation signal and to couple the light through the light- and/or sound-transparent element into the inner chamber of the valve body separated by the light- and/or sound-transparent element.

3. The valve body of claim 1, further comprising:
at least one sound source configured to generate sound in response to a supplied actuation signal and to couple the sound through the light- and/or sound-transparent element into the inner chamber of the valve body separated by the light- and/or sound-transparent element.

4. The valve body of claim 1, further comprising:
at least one sensor device configured to receive light and/or sound from the inner chamber through the at least one light- and/or sound-transparent element and to generate a sensor signal representing at least one characteristic of the light and/or sound received through the at least one light- and/or sound-transparent element.

5. The valve body of claim 1, further comprising:
a plurality of openings spaced apart from one another and each extending into the inner chamber of the valve body, each of the plurality of openings being closed by a corresponding light- and/or sound-transparent element.

6. The valve body of claim 5, wherein:
the valve seat divides the inner chamber into a first part and a second part;
a first opening of the plurality of openings extends into the first part of the inner chamber; and
a second opening of the plurality of openings extends into the second part of the inner chamber.

7. The valve body of claim 4, wherein:
the at least one sensor device is configured to generate at least one digital image representing a state of at least part of the inner chamber of the valve body as the at least one characteristic represented by the sensor signal.

8. The valve body of claim 7, wherein:
a region of the valve body in which a shut-off body moves to open and close the process valve during operation of the process valve lies at least partially within a field of view of the at least one sensor device.

9. The valve body of claim 5, further comprising:
at least one light source configured to couple monochromatic light in the form of a light distribution into the inner chamber of the valve body in a main emission direction through a first associated one of the light- and/or sound-transparent elements; and
at least one sensor device configured to record at least a light intensity of light scattered by suspended particles in a process fluid from the light distribution emitted in the main emission direction through a second associated one of the light- and/or sound-transparent elements.

10. The valve body of claim 1, further comprising:
at least one clamping section for abutting a lateral region of a shut-off body configured as a valve diaphragm,
wherein the at least one clamping section surrounds a seat opening configured to be closed by the valve diaphragm, and
wherein the seat opening extends into the inner chamber of the valve body and to the valve seat.

11. The valve body of claim 10, further comprising:
at least one sensor device,
wherein an optical axis of the at least one sensor device passes through a portion of one of the process fluid channels and through the seat opening, the portion connecting a process fluid port and the seat opening.

12. A process valve comprising:
the valve body of claim 1;
a shut-off body configured to:
when the process valve is closed, press on the at least one valve seat of the valve body and block fluid from flowing through the process valve; and
when the process valve is open, lift off the at least one valve seat and allow fluid to flow through the process valve; and
a drive configured to move a valve stem,
the valve stem being movably mounted along an adjustment axis and moving the shut-off body.

13. A method for operating a process valve, the method comprising:
performing at least one of:
(a) operating at least one light source to generate light in response to a supplied actuation signal, wherein the light generated by the at least one light source is coupled through a light- and/or sound-transparent element into an inner chamber of a valve body of the process valve that is separated by the light- and/or sound-transparent element, and wherein the light- and/or sound-transparent element closes an opening extending into the inner chamber of the valve body; and
(b) operating at least one sensor device to generate a sensor signal representing at least one characteristic of light and/or sound received through the light- and/or sound-transparent element closing the opening or through a further light- and/or sound-transparent element closing a further opening of the valve body.

14. The method of claim 13, wherein:
the sensor signal generated by the at least one sensor device comprises at least one digital image representing at least a first portion of a wet-side surface of a shut-off body of the process valve located in a field of view of the at least one sensor device.

15. The method of claim 14, further comprising:
opening the process valve such that the shut-off body is at least partially lifted off a valve seat; and
operating the at least one light source and simultaneously operating the at least one sensor device to obtain the at least one digital image while the shut-off body is at least partially lifted off the valve seat.

16. The method of claim 15, further comprising:
operating the at least one light source to generate light coupled into the inner chamber of the valve body;
operating the at least one sensor device while the light is radiated into the inner chamber such that the at least one sensor device obtains the at least one digital image while the shut-off body is at least partially lifted off the valve seat,
wherein the at least one sensor device receives incident light from a first part of the inner chamber through a first light- and/or sound-transparent element, and
wherein the first part and a second part of the inner chamber are separated by the valve seat; and
operating a further sensor device while the light is radiated into the inner chamber such that the further sensor device obtains at least one further digital image while the shut-off body is at least partially lifted off the valve seat,
wherein the further sensor device receives incident light from the second part of the inner chamber through a second light- and/or sound-transparent element.

17. The method of claim 13, further comprising:
closing the process valve such that a shut-off body of the process valve moves onto a valve seat and divides the inner chamber of the process valve into a first part and a second part;
operating the at least one light source to generate light within a time period after the process valve has closed,
wherein the at least one light source radiates the light into the second part of the inner chamber through a light- and/or sound-transparent disk delimiting the second part of the inner chamber;
operating the at least one sensor device after the process valve has closed and during operation of the at least one light source to generate the sensor signal,
the sensor signal representing at least one light intensity of light received from the first part of the inner chamber through the light- and/or sound-transparent disk or through another light- and/or sound-transparent disk delimiting the first part of the inner chamber; and
ascertaining a closure quality of the process valve based on the at least one light intensity.

18. The method of claim 13, further comprising:
ascertaining a first turbidity value for a process fluid based on the sensor signal generated at a first point in time by the at least one sensor device;
ascertaining a second turbidity value for the process fluid based on the sensor signal generated at a second point in time later than the first point in time by the at least one sensor device; and
opening or closing the process valve based on the first turbidity value and the second turbidity value when a difference between the first turbidity value and the second turbidity value exceeds a limit value.

19. The method of claim 13, further comprising:
transmitting the sensor signal and/or at least one parameter derived therefrom via a communication interface to a mobile terminal and/or to a process controller.

20. A control unit for a process valve, the control unit comprising:
at least one processor;
at least one memory storing program instructions executable by the at least one processor; and
a communication interface,
wherein execution of the program instructions causes the control unit to:
generate an actuation signal to operate at least one light source or at least one sound source;
receive and process a sensor signal from at least one sensor device; and
transmit the sensor signal and/or at least one parameter derived therefrom via the communication interface.
